(19) United States
(12) Patent Application Publication
(10) Pub. No.: US 2013/0067877 A1
(43) Pub. Date: Mar. 21, 2013

(54) AIR CLEANING FILTER

(71) Applicants: George Griffiths, Lancashire (GB); Geoffrey Norman Walter Gay, Fairfield, IA (US)

(72) Inventors: George Griffiths, Lancashire (GB); Geoffrey Norman Walter Gay, Fairfield, IA (US)

(21) Appl. No.: 13/613,703

(22) Filed: Sep. 13, 2012

(30) Foreign Application Priority Data
Sep. 17, 2011 (GB) 1116153.6
May 16, 2012 (GB) 1208602.1

(51) Int. Cl. B01D 46/52

(52) U.S. Cl. 55/499; 55/497

(57) ABSTRACT

An air cleaning filter for an air conditioning system comprising a rigid frame having a length, a width and a depth, to which flexible filter material is mounted, the filter material being of greater cross-sectional area than the rigid frame, and including at least two peaks and one trough therein, the maximum peak-to-trough amplitude of which is greater than the depth of the rigid frame. The length and width of the filter are adapted so as to be positioned, in use, in a direction that is substantially perpendicular to the direction of airflow of the air being filtered, whilst the depth thereof is adapted so as to be positioned, in use, in a direction that is substantially parallel to said direction of airflow.

The present invention relates to air cleaning filters.

In air conditioning systems, standard air cleaning filters are inserted into standard slots, for example in a return air duct or at a return air grille, to filter air that passes through the system of unwanted particles. In the former case, the standard slot may be formed by cutting into a duct wall. The slot may be provided with guide runners to assist in positioning the filter as it is inserted into the slot, and thereafter to hold the filter in position once fully inserted. In the latter case, the slot may be provided in the grille itself; the grille may also be provided with guide runners. Although described with reference to air conditioning systems, the air cleaning filters according to the invention have utility in all other fields, such as in the nuclear industry, the automotive industry, the aeronautics industry, etc., where cleaning and filtration of air or other gases is required. As such the term “air” is to be construed accordingly broadly.

“Standard” filters have a length and a width defining the two larger dimensions thereof, and a depth defining the smallest dimension thereof. Such filters are designed so as to be substantially rectangular (defined by length and width) in a plane orthogonal to the direction of airflow through the air conditioning system, with the filter depth thus extending parallel to the direction of airflow.

“Standard” slots in air conditioning systems are most commonly distinguished by their widths. The “width” of a standard slot is the dimension of said opening which extends parallel to the airflow direction, into which a standard filter may be inserted. A typical width for a standard slot is one inch (equivalent to 25.4 mm), and as is referred to as such in the industry, however other multiples such as two inches (equivalent to 50.8 mm), three inches (equivalent to 76.2 mm), etc. are also known, albeit less commonly.

The depth of a standard filter will usually be slightly less than the width of a standard slot to facilitate easy insertion, i.e. less than one inch, and typically around 22 mm. The other two dimensions (length and width) of the filter, in the plane orthogonal to the direction of airflow, are typically standardized to match the cross-sections of duct encountered in a range of typical air conditioning installations, for example some commercially available sizes include (in inches): 16×16; 16×20; 16×25; 20×20; 20×25 and 20×36.

Such standard filters typically comprise a fibrous filter material that is pleated to provide a larger surface area than the corresponding cross-sectional area of the air duct into which the filter is to be fitted, thus ensuring a low pressure drop across the filter to allow normal functioning of the air conditioning system. The peaks and troughs of the pleats of the filter material extend parallel to direction of airflow. The fibrous filter material is usually presented and maintained in a cardboard frame, optionally attached to a wire support, which may be inserted into the standard slot. The materials, complexity and manufacturing cost of such filters are low.

Standard filters cannot have a depth that is greater than the width of the standard slot into which it is to be inserted. Therefore the pleats of the filter material are subject to the same depth restriction as the filter overall as discussed earlier, and in practice need to be of a lesser depth for easy insertion. Thus the peaks and troughs of the filter pleats cannot extend beyond the depth of the standard filter frame. This restriction limits the degree of pleating of the filter material and therefore the total available surface area of the filter material provided. In turn, this restricts the filtration efficiency achievable.

It is not possible to simply increase the number of pleats per unit filter area as such a measure will ultimately result in a pressure drop across the filter due to restriction of the air flow by the smaller gap between pleats. This presents a further limitation on the filtration efficiency obtainable with a currently available standard filter.

The original purpose of filtration in an air conditioning system was to protect the surfaces of the heat exchanger therein from becoming fouled up with dirt and other such undesirable particulate matter, which would often lead to a reduction in heat transfer efficiency. Over the last two decades however, new interest has arisen in being able to remove airborne particles that may have an adverse effect on human health. Such particles include viral particles and bacteria suspended alone or in aerosols, smoke particles, dusts, pollen and mould spores. The diameter of these airborne particles is often smaller than the diameter of the dirt particles which cause fouling of the air conditioning equipment, and therefore, their removal requires a filter of superior filtration performance as compared to a conventional air cleaning filter, i.e. a filter providing useful filtration efficiency for smaller particle sizes.

Unfortunately the filtration efficiency of standard filters is low for particle sizes below one micron diameter, including the aforementioned “health sensitive” particle sizes. For example, the typical efficiency of a newly installed, commercial, one inch slot filter in an air conditioning system experiencing a through-air velocity of 2.5 metres per second is 99% for particles of 5 micron diameter (relatively large particles). However, the efficiency of the same filter at the “health sensitive” particle size of 0.3 microns is only 50% initially, and falling to 20% after 7 days of use.

More efficient filters such as electrostatic precipitators, involving particle charging apparatus in conjunction with charged collector plates or charged fibre filters, have been fitted to air conditioning systems, however expert installation is required (at a cost). Furthermore, such filters are considerably more complex and expensive than the aforementioned standard filters, and require more space in the direction of airflow than the width of a standard slot in an air conditioning system.

US 2005/0204922 A1 teaches the use of a collapsible frame that has components to carry a particle collector and a relatively moveably air conditioning element such as a particle charger, which together in their “use” position would not fit into a standard slot. Such a collapsible frame can however be inserted into the standard slot in a return duct by firstly collapsing the frame, inserting the collapsed frame into the slot, and subsequently expanding the frame, thus enabling the deployment of high efficiency particle filtration. The collapse and subsequent expansion is effected by means of an expansion mechanism of levers and struts operated from outside of the duct once the filter assembly has been inserted into the duct; such mechanism increases the gap between, for example, the particle charging element and the collector or filter. It should be noted that the collapsible frame of US 2005/0204922 Al merely increases the separation between components such as a collector, filter or particle charger by movement of the carrier frames along the inner space of the duct. No such component can have a depth in the direction of airflow greater than the standard filter slot, and in practice needs to be smaller for insertion into the carrier frame, which itself must fit into the slot in its compressed form. Such an arrangement utilizes a more complex and expensive filtration method than a standard filter and the collapsible frame with its mechanical and support elements adds considerably to the total cost.

Another more efficient method of air filtration which has been developed and become more popular over the last few years is the use of pleated filters of depth greater than a standard “one inch” filter. As mentioned earlier, these filters may have depths of, typically, two inches, three inches, four inches and five inches. The advantages of these filters is that they have considerably improved efficiencies and a much longer lifetime before they are fully loaded with dust and need replacing. However, again, the disadvantage of using such filters lies in the fact that they are too deep to fit into the one inch width of a standard air filter slot, and therefore a significant extra cost for installing the required filter housing cabinet in the air conditioning system in order to facilitate the insertion and removal of these larger filters must be incurred. Another difficulty that sometimes occurs is that that there is not enough space available in the proximity of the air handling system to fit this extra filter housing cabinet.

Other prior art documents, such as EP1616736A1 and WO2008/055971A1, show folded filters which have elastic or compressible filter frames which allow the frame and filter material to be deformed such that the filter can be threaded through a mounting opening of a filter housing which is smaller in a direction orthogonal to the direction of airflow than one of the dimensions of the filter which is positioned orthogonally to the airflow. Such elastic or compressible filter frames allow the filter to be squeezed through a narrow opening, particularly in the restricted space available in the engine compartment of an automobile. This allows for the easier replacement of a filter but does not give scope for an increase in filter efficiency, as the depth of the said filter remains equal to or less than the width in the direction of airflow of the filter slot. In addition, the requirement of a flexible or compressible filter frame adds to the complexity and cost of the filter design.

Thus a need remains to provide high efficiency air filtration at low cost in a standard slot of an air conditioning system or other air cleaning system.

According to the present invention there is provided an air cleaning filter for an air conditioning system, said filter comprising: a rigid frame having a length, a width and a depth, to which flexible filter material is mounted, the filter material being of greater cross-sectional area than the rigid frame, and including at least two peaks and one trough therein, the maximum peak-to-trough amplitude of which is greater than the depth of the rigid frame.

An air cleaning filter according to the invention is preferably provided in any one or more of the standard (currently available) dimensions discussed earlier, and is designed to be deployed in a standard slot in the plane orthogonal to the direction of airflow in an air conditioning system. Unlike prior art air cleaning filters however, a filter according to the invention is of a greater depth in the direction of airflow than the width of the standard slot in which it is deployed, without the need for mechanical structures or complex expandable or flexible or compressible frame designs. Thus higher efficiency air filtration, especially for filtration of smaller “health sensitive” particle sizes, can now be provided at a considerably lower complexity and cost than was hitherto possible.

The air cleaning filter according to the invention is preferably designed such that the length and width thereof are adapted so as to be positioned, in use, in a direction that is substantially perpendicular to the direction of airflow of the air being filtered, whilst the depth thereof is adapted so as to be positioned, in use, in a direction that is substantially parallel to said direction of airflow.

The flexible material may be a sheet of such material. Such a sheet of flexible filter material may be provided within the rigid frame, rather than, for example, being fitted over the frame.

By defining the filter material as being flexible, it is meant that it is able to be deformed. The deformation is preferably elastic such that the material has a “shape-memory” and is able to revert to a defined configuration (of at least two peaks and one trough) from a deformed configuration.

By stating that the sheet of filter material is of greater cross-sectional area than the rigid frame, it is meant that the frame has a cross-sectional area defined by its length and its width, which is smaller than the flattened area of the sheet of filter material.

The sheet of filter material including at least two peaks and one trough therein may be described as undulating, i.e. having a number of peaks and troughs. The undulations in the material may be in the form of pleats, having well-defined creases at the apices thereof.

The sheet of filter material may undulate about a plurality of guides, for example lengths of guide wire, or other such suitable material, and may be fixed thereto. Said guides may extend within the filter frame, spanning the length and width thereof. The plurality of guides may be evenly spaced apart such that the at least two peaks and one trough are provided uniformly. With numerous peaks and troughs in the sheet of filter material, provision of a plurality of guides ensures that they are regularly and evenly spaced, such that each peak-to-trough has the same maximum amplitude.

In one embodiment, the maximum amplitude of the at least two peaks and one trough provided in the sheet of material may only be achievable when air is being filtered through by the filter, i.e. when air causes the sheet of filter material to adopt its intended configuration of peaks and troughs (the material otherwise possibly collapsing within the frame into a non-defined configuration).

In the present invention, the filter comprises a rigid filter frame capable of being accommodated in a standard air filter slot with filter material pleated to a greater depth than the standard slot width, the said peaks and troughs, preferably pleats, being collapsible so as to occupy a depth in the direction of airflow equal to or smaller than the width of the filter slot and being capable of re-erection to a greater depth once inside the slot. Thus a larger area of filter medium than with a standard filter may be deployed in the return duct providing higher efficiency filtration without the complication of moveable or flexible frames and mechanical levers and the like. Thus high efficiency filtration may be provided in a standard slot simply and at low cost.

Suitable filter materials preferably ought to be flexible without incurring damage as a result of any compression and expansion of the pleat folding. Suitable materials include those composed of charged or uncharged polymer fibres, such as are currently deployed in the standard one inch slot air filters.

A typical standard one inch slot air filter has pleats of height 20 mm (i.e. a maximum peak-to-trough amplitude of 20 mm) and a spacing from one pleat peak to the next pleat peak (on the same side of filter) of 30 mm. If the principle of the present invention were applied to such a filter, allowing the pleat height (i.e. the maximum peak-to-trough amplitude) to increase by three times to 60 mm while keeping the pleat spacing the same, then the total filter area would increase by a factor of approximately 2.47. This would reduce the air velocity through the filter material by the same factor and therefore give a significant increase in filter efficiency and lifetime. In addition, as the reduced air velocity through the filter material results in a lower pressure drop for the same material thickness as a standard filter, an even greater total amount of filter material can be deployed in filters according to the present invention, by increasing the material thickness so as to return to the higher pressure drop typical of standard filters, thus further improving both efficiency and lifetime. Practical filters may be made according to this invention to fit into a standard filter slot with a range of pleat heights up to at least three or four times the standard filter slot width, thus providing the filtration performance of equivalent depth filters without the additional need for filter housing cabinets.

It is envisaged that frame materials similar to those employed in standard filters may be used in embodiments of the present invention, in order to form a rigid frame whose shape does not need to change in order to insert the filter into a standard filter slot, such as the traditional folded and glued cardboard, thus keeping manufacturing simple and costs low. Alternatively, vacuum formed and/or stamped thin sheets of plastics polymer may be used to fabricate the frame.

In one embodiment of the present invention the filter may be supplied in a collapsed state (albeit with the frame being rigid) and inserted into the filter slot in this collapsed state. Once inserted into said slot, the collapsed peaks, preferably pleats, may be re-erected by various means, including the removal of a component restraining the collapsed pleats from re-erecting under the influence of inherent resilience, or springiness, in the filter material, or a resilient, or springy, support, or suitably disposed resilient elements, such as springs. A further re-erection means may be provided, such as a lever arrangement causing unfolding of the collapsed peaks, preferably pleats, said lever being operable from outside of the filter slot.

Such filters, if provided with inherent resilience or springiness or with a resilient or spring support, may be packaged in such a way that the enclosing packaging restrains the filter in the collapsed state. Alternatively a simple catch or drawstring may be used to restrain the filter in a collapsed state. It should be understood that the force of insertion of a resilient, or springy, filter can be the cause of compression as the filter moves into the smaller width of the standard slot, such that the pressure exerted on the filter material by the immovable slot edges causes compression of the said peaks, preferably pleats, thus enabling their insertion into the slot. Subsequently, the inherent resilience, or springiness, of the filter material as exhibited by the pleats or provided by the pleat supports, may cause erection of the filter pleats to the intended operating pleat height within the duct.

In a further embodiment of the present invention, the filter may comprise filter material pleated to a greater depth than the standard slot width, the said pleats being provided with inherent springiness in the filter material or a springy support or suitably disposed spring elements such that, as the filter is inserted into the standard slot, each pleat automatically folds as it enters and then expands once inside, progressively one by one for each of the pleats until the filter is fully inserted into the slot. The same process is repeated during the removal of the folding filter, each pleat folding in the opposite direction as the filter is drawn out of the slot.

For a better understanding, the invention is now further described by means of specific, non-limiting embodiments illustrated in the following schematic figures (not to scale), in which like numbers designate like components through all figures, in which:

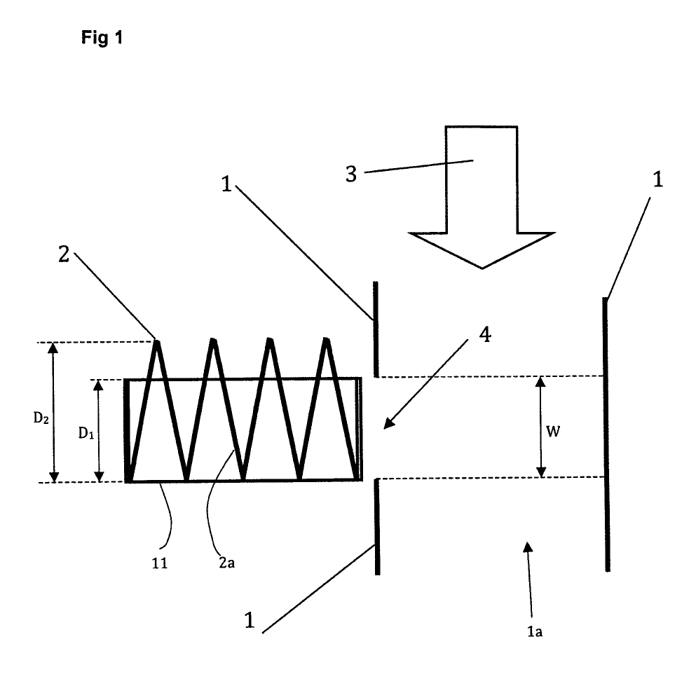

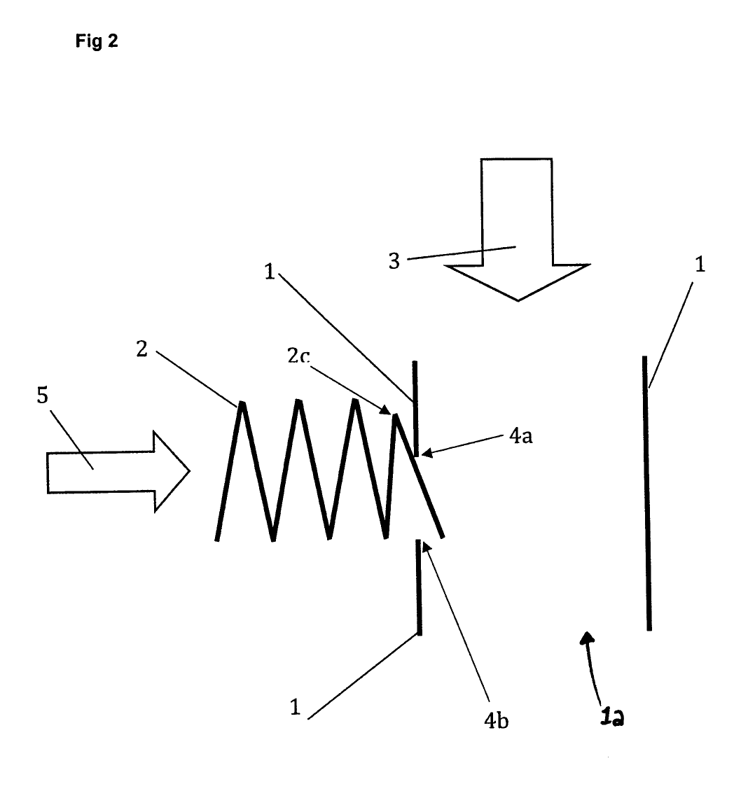

FIGS. 1, 2, 3 and 4 show a cross section of a filter of the present invention in four successive stages of insertion into a standard one inch filter slot in a return duct of an air conditioning system;

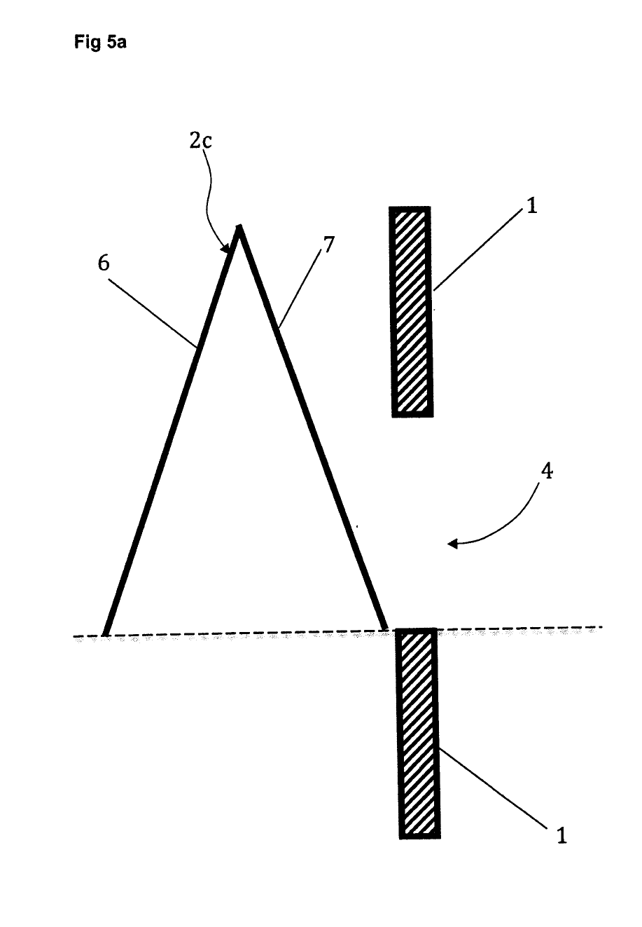

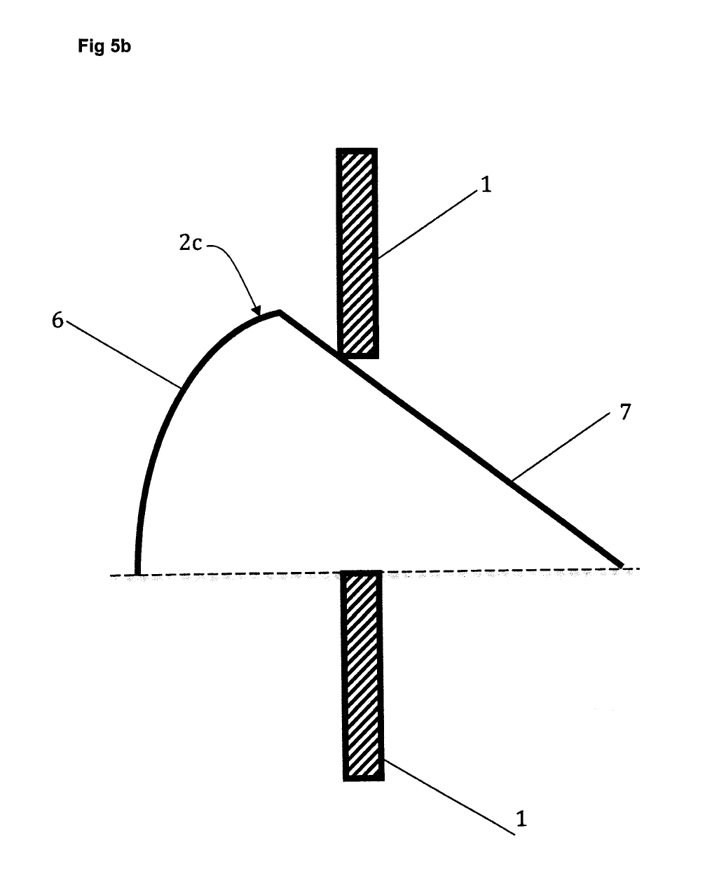

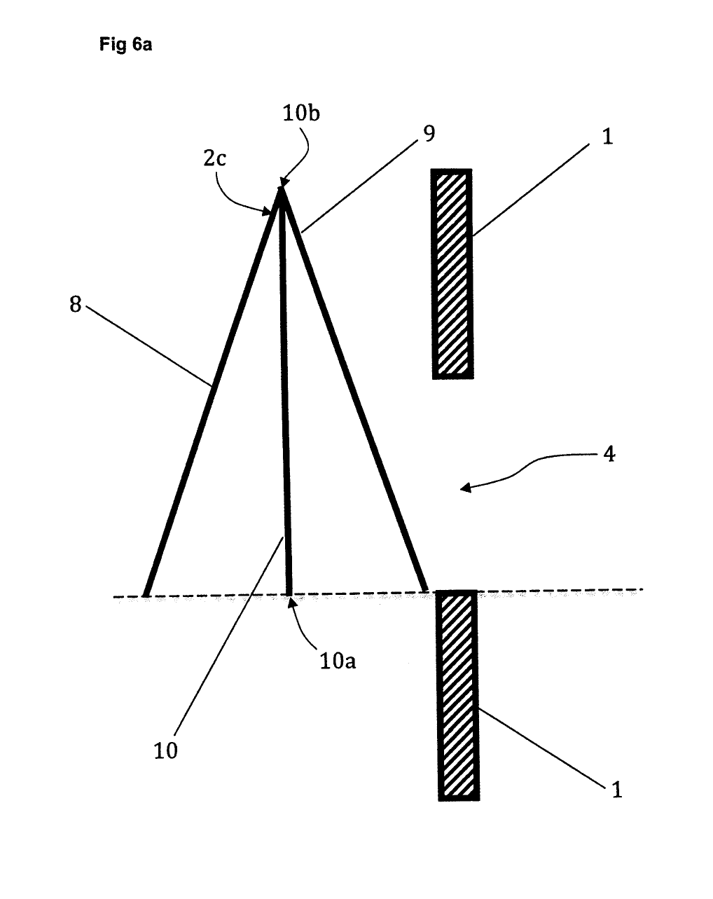

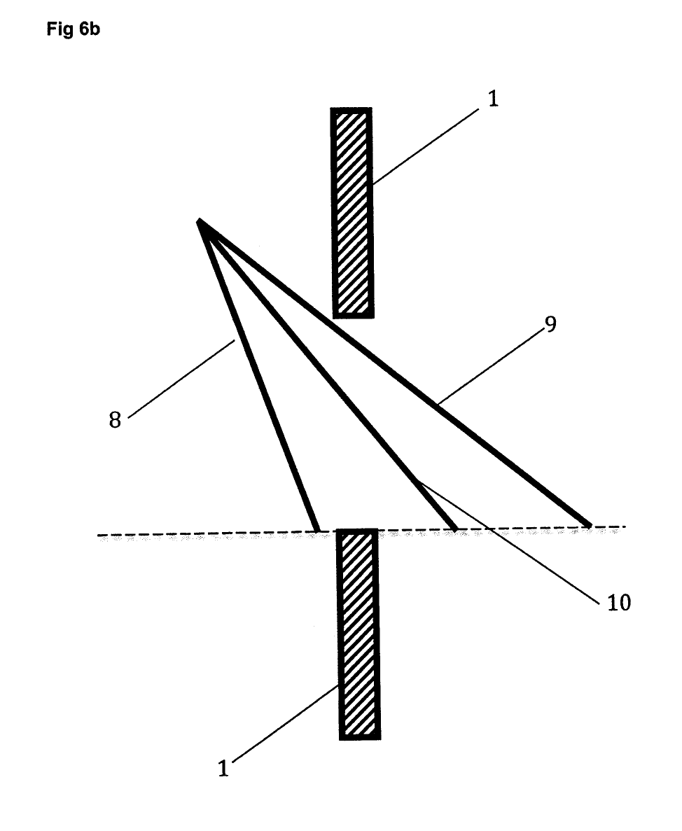

FIGS. 5a, 5b, 6a and 6b show a single pleat of a filter of the present invention in different states of flexion during entry into the filter slot;

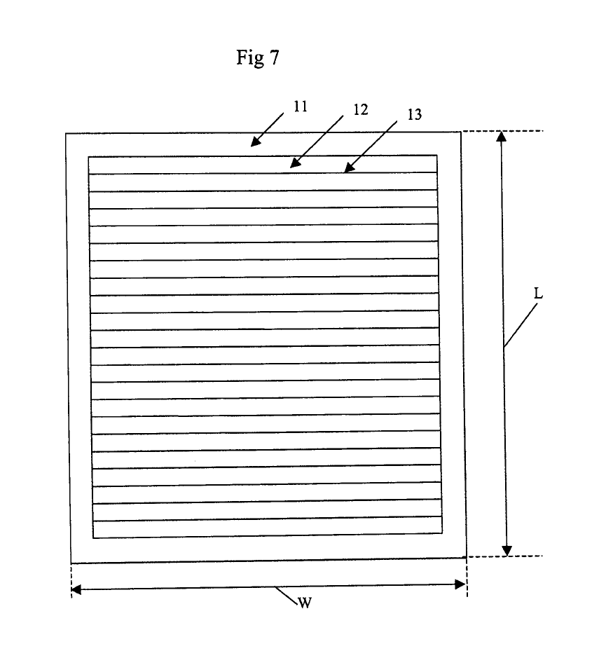

FIG. 7 shows a plan view in the plane orthogonal to airflow of one embodiment of the filter of the present invention mounted in a rigid frame;

FIG. 8 shows a similar filter as that shown in FIG. 7 in perspective view, with a smaller number of pleats for clarity;

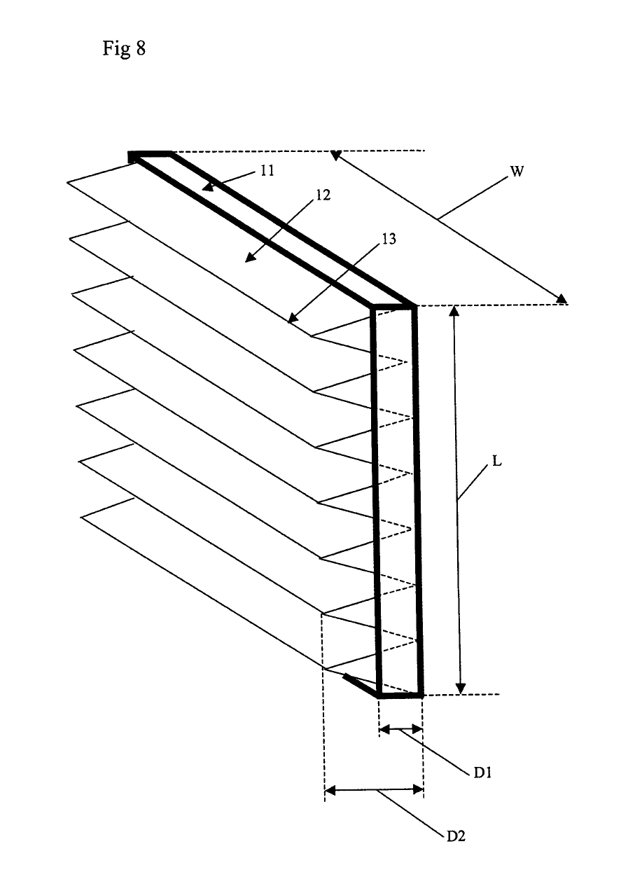

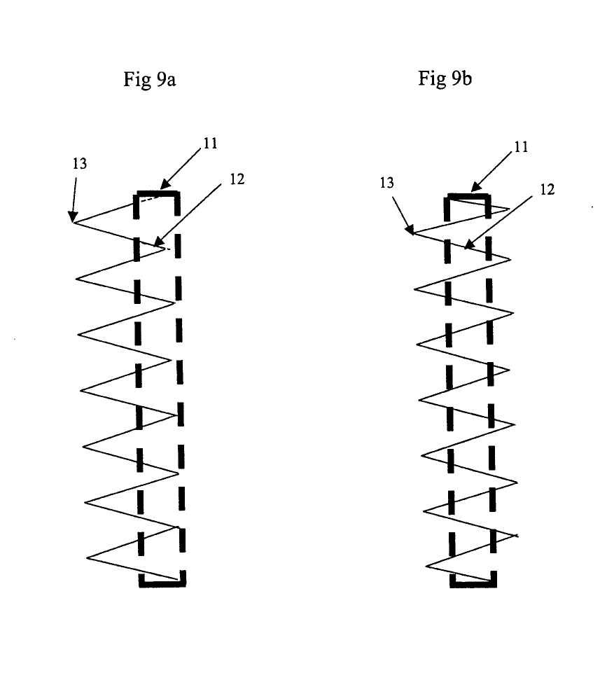

FIGS. 9a and 9b each show a cross section at right angles to the pleat folds of a filter similar to that shown in FIG. 8;

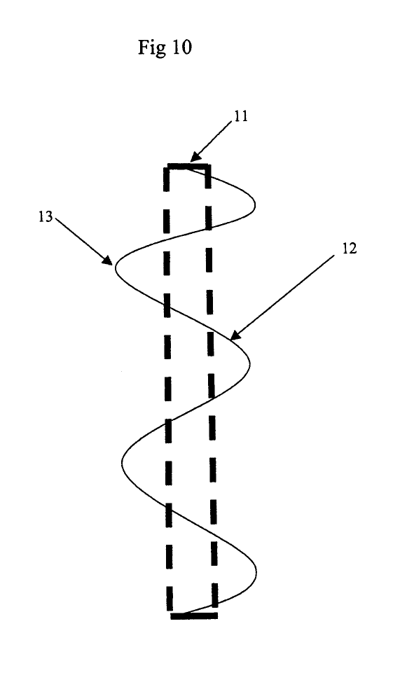

FIG. 10 shows a filter of the present invention with an alternative wave like shape of pleats;

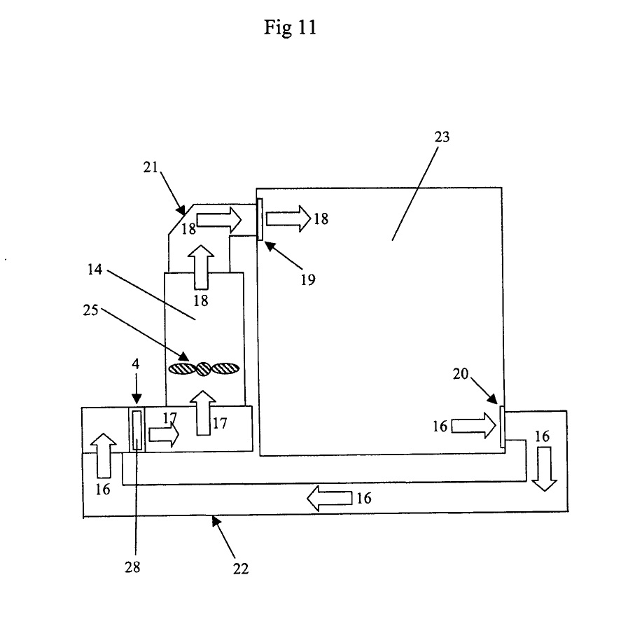

FIG. 11 shows a typical air conditioning system;

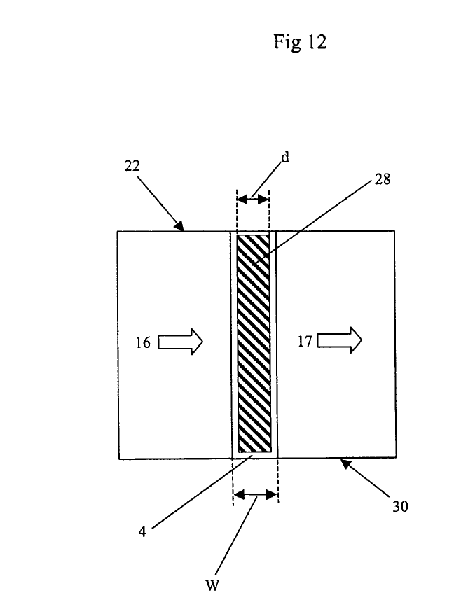

FIG. 12 shows in greater detail than FIG. 11 a cross section of a standard (prior art) air filter in a standard slot in the return air duct;

FIG. 13 shows a cross section of an air filter of the present invention inserted into a standard slot in the return air duct and subsequently expanded to occupy its full operational depth;

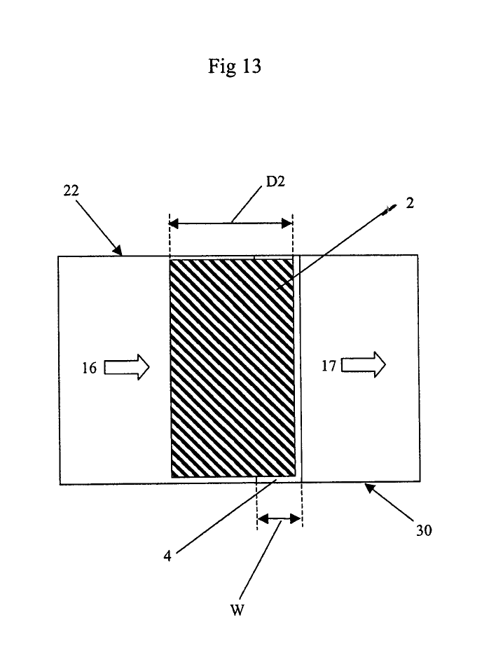

FIG. 14a shows a fully deployed filter in accordance with a further embodiment; FIG. 14b shows the filter of FIG. 14a in a folded state;

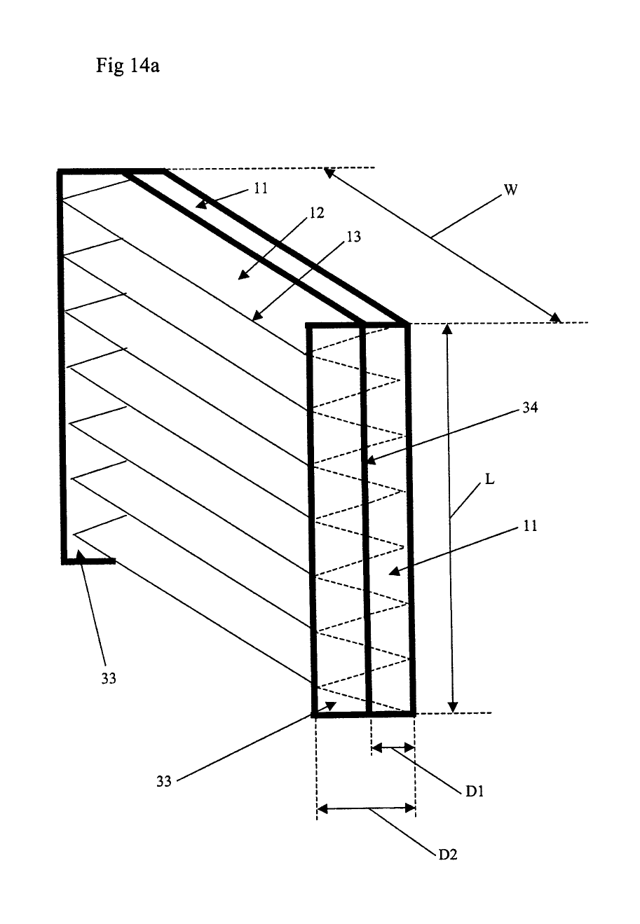

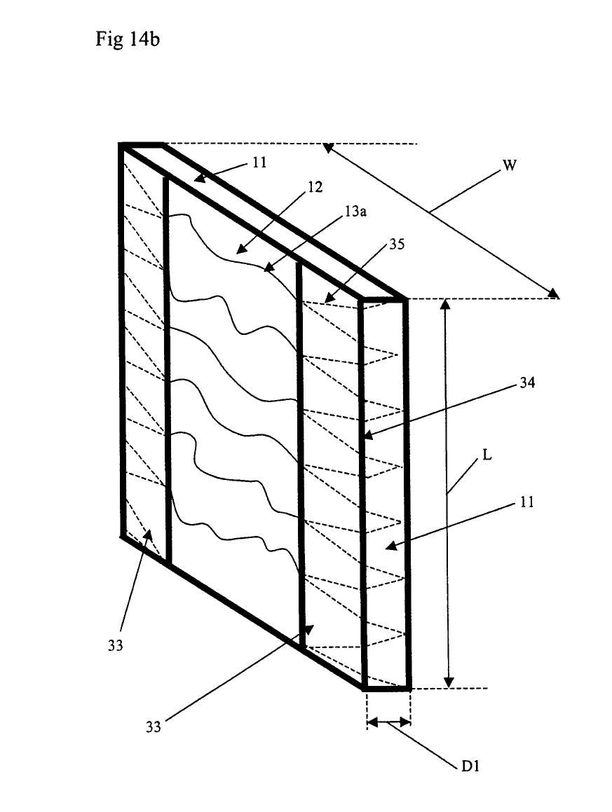

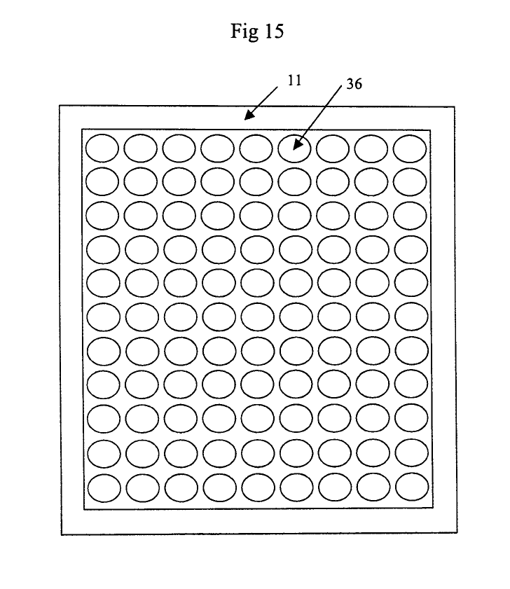

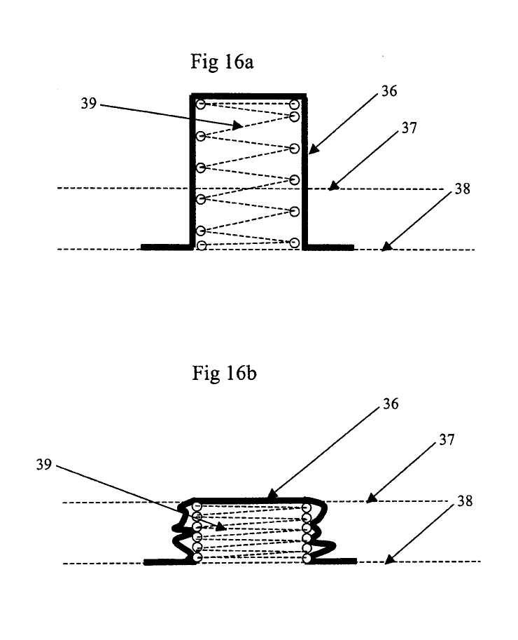

FIG. 15 shows a further embodiment of the invention; FIGS. 16a and 16b show a single bag of the filter of FIG. 15;

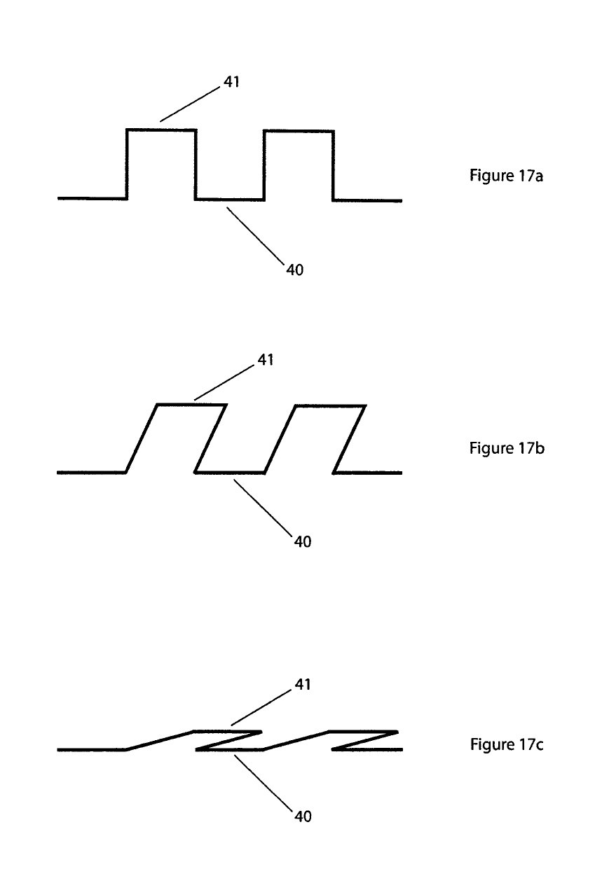

FIGS. 17a, 17b and 17c illustrate the principle of folding down rectangular pleats to an almost flat state;

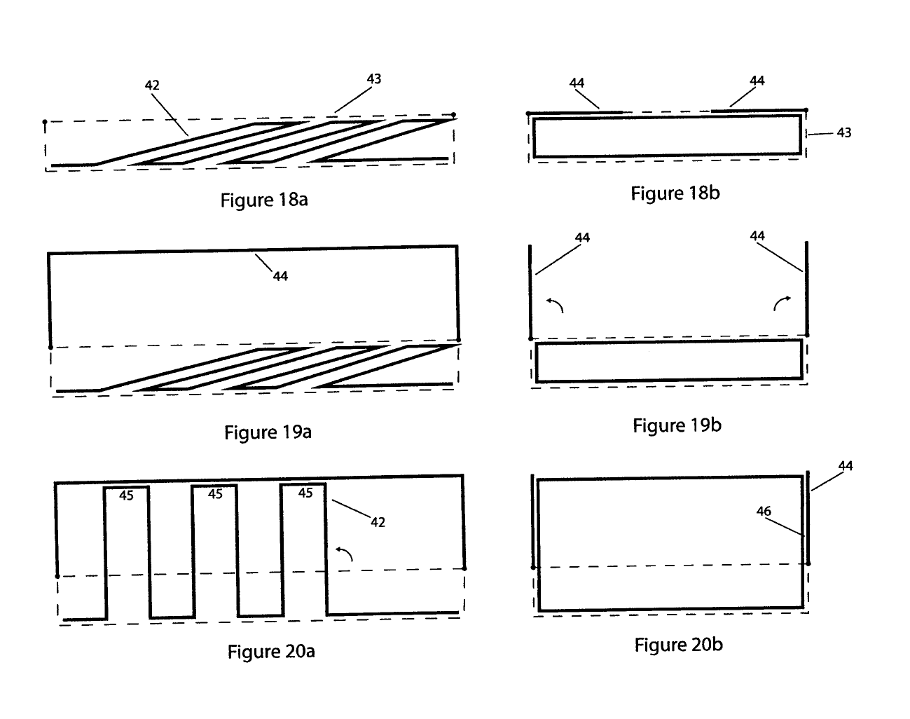

FIGS. 18a and 18b show the filter of FIGS. 17a, 17b and 17c fully folded down prior to insertion in the standard slot;

FIGS. 19a and 19b show the filter of FIGS. 17a, 17b and 17c fully inserted; and

FIGS. 20a and 20b show the filter of FIGS. 17a, 17b and 17c fully inserted and fully deployed.

FIG. 1 shows an air cleaning filter 2 prior to its insertion into a standard slot 4 in a duct la defined by duct walls 1. Filter 2 comprises a rigid frame 11 in which a sheet of flexible filter material 2a is mounted. The direction of airflow is indicated by arrow 3. It will be noted that the depth, D2, of the filter 2 is greater than the width, W, of the slot 4, whilst the depth, D1, of the frame 11 is less than the width, W, of the slot 4. The sheet of filter material 2a is pleated, and as is clearly shown, with the maximum peak-to-peak amplitude of each peak (which is equivalent to depth, D2, of the filter 2) being greater than the depth, D1, of the frame 11.

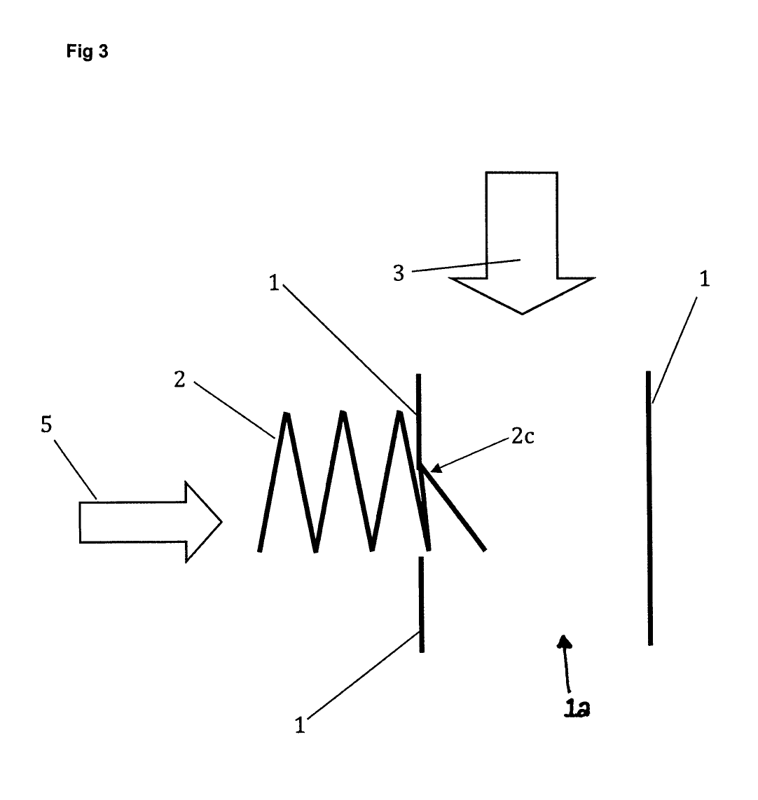

FIG. 2 shows the same filter 2 as FIG. 1 but now partially inserted into the slot 4 by means of an applied force whose direction is indicated by arrow 5. The first pleat 2c to contact the upper slot edge 4a (the lower edge slot being denoted 4b) is pressed down causing the pleat to lean in the opposite direction to the direction of insertion.

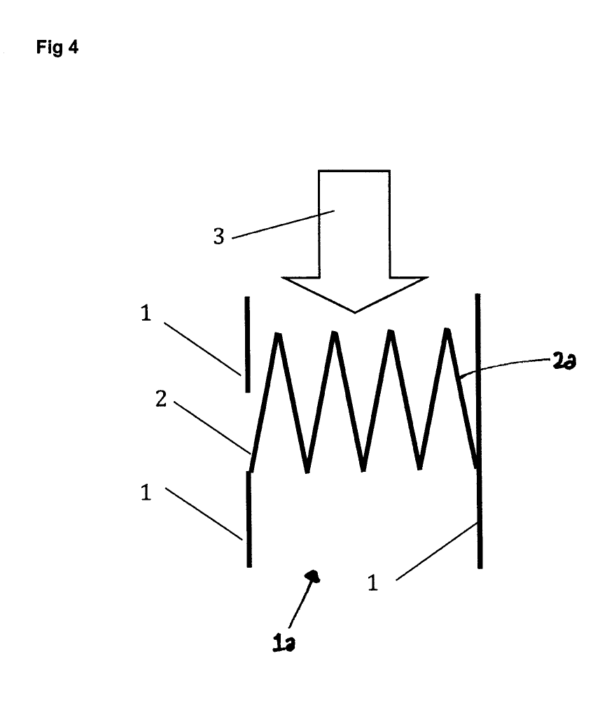

FIG. 3 shows the same filter 2 at the point where the insertion has caused the height of the first pleat 2c to equal the width, W of the slot, causing this pleat 2c to enter the duct 1a.

FIG. 4 shows the same filter 2 at the point where all pleats have entered the duct 1a and the pleats have returned to their original configuration (as shown prior to insertion into slot 4) due to the elasticity of the sheet of flexible filter material 2a.

FIG. 5a shows pleat 2c before insertion into slot 4, whilst FIG. 5b shows pleat 2c during insertion into slot 4. During insertion, the backward pleat side 6 bows out (in a direction away from slot), whilst the forward pleat side 7 is compressed under the force of insertion.

FIGS. 6a and 6b show a filter support 10, in the form of a springy flexible strip, that lies along the length of the pleat 2c. Support 10 is fixed at one of its edges 10a to the filter frame 11, whilst the opposite edge 10b supports the filter material 2a at the apex of the pleat 2c. FIG. 6a shows pleat 2c prior to insertion into slot 4, whilst FIG. 6b shows pleat 2c during insertion into slot 4. The filter material 2a is fixed to the filter frame 11 on either side of the support strip 10 but is free to slide over the unattached edge of the support strip. Thus as the pleat 2c is inserted, the support strip bends backwards as the filter moves forwards into the slot 4 and the filter material slides over the support strip from side 8 to side 9 allowing the pleat as a whole to flex backwards and enter the duct. Once in the duct, the strip springs back to its normal position, erecting the pleat of filter.

It is also possible to cause the folding and re-erection of each pleat by means of spring components attached to a mesh or support strip or other supporting movable elements, said spring elements anchored, for example, to the filter frame.

As shown in FIG. 7, pleat sides 12 and pleat folds 13 are contained within and supported by the rigid frame 11. The airflow direction in this diagram is orthogonal to the plane of the drawing, and the depth of the filter is measured in this direction. The dimensions of the filter orthogonal to the airflow are therefore shown as its length, L, and its width, W. These dimensions are chosen so as to fit across the duct cross section and are supplied in standard sizes as described above.

As shown in FIG. 8, again the dimensions of the filter orthogonal to airflow are shown as L and W. However in this view the filter depth, D2, and the filter frame depth, D1, are also shown. A standard filter as known in the prior art would have a filter depth, D2, approximately equal to the frame depth, D1, in other words, the pleated filter material would be completely enclosed by the frame dimensions. However in a filter of the present invention, the filter material 2a can compress to enter the width, W, of the standard slot 4 and subsequently expand to its full operational depth, D2, which is greater than the frame depth, D1, and the slot width, W.

FIGS. 9a and 9b each show a cross section at right angles to the pleat folds of a filter similar to that of FIG. 8, where in FIG. 9b the filter material projects on both sides of the frame and in FIG. 9a on one side only. Obviously the ratio of this projection between the filter sides can be varied according to the requirements of specific duct geometry.

It will be appreciated that the cross section form of the pleats can be shapes other than the triangular shape illustrated in the above-mentioned figures. An undulating or wave like shape can be used. In all cases the pleat shape can be supported and/or elastically maintained by means of a springy support frame or support element frame or mesh (not to be confused with the rigid filter frame itself), as described above. Alternatively the ends of the pleats can be attached by means of adhesive to the adjacent internal frame walls so that the pleat shape, established thus at each end of the filter, is maintained across the face of the filter. Or a combination of these methods can be employed. In cases where the pleats extend beyond the frame in the direction of airflow, air bypass can be prevented by sealing the open flute ends with fillets of material or by gluing or sealing the open edges together so that filtration efficiencies are maintained.

FIG. 10 shows a filter of the present invention with an alternative wave like shape of pleats. It will be understood that the shape of this type of pleat can be maintained with the same methods as outlined above for triangular pleats. In other words the pleat ends can be glued to the frame sides or supportive structures can be provided.

As shown in FIG. 11, an air conditioning unit 14 supplies air-conditioned air in the direction indicated by arrows 18 via the air supply duct 21 and air supply grille or register 19 into the room 23. After circulation in the room the air then returns in the direction indicated by arrows 16 via air return grille or register 20 to the standard filter 28 in the standard slot 4. The filtered air then flows in the direction of the arrows 17 to the inlet side of the air conditioning unit 14. This air flow is driven by a fan or blower 25.

As shown in FIG. 12, the standard filter 28 of depth, d, is shown in place in the standard filter slot 4 of width, W. Returning air from the room (not shown) flows in the direction of arrow 16 through the return duct 22 and into the standard filter slot 4 and thus through the standard filter 28 and thence the filtered air flows in the direction of arrow 17 through the air conditioning unit inlet duct 30 to the air conditioning unit (not shown). It will be noted that the standard filter slot width, W, is greater than the standard filter depth, d, to allow easy insertion, with the filter material in the standard filter being completely enclosed within the volume defined by the frame of filter depth, d.

In FIG. 13, the air filter 2 of the present invention of depth, D2, is shown in place in the air return duct 22. Returning air from the room (room not shown) flows in the direction of arrow 16 through the return duct 22 through the air filter 2 of the present invention and thence the filtered air flows in the direction of arrow 17 through the air conditioning unit inlet duct 30 to the air conditioning unit (not shown). It will be noted that the depth, D2, of the air filter of the present invention is greater than the depth, d, of the standard filter slot 26 thus providing a higher filtration performance than a standard filter of prior art intended for the standard air filter slot. It will be appreciated that the expansion of the inserted filter can also be downstream of the filter slot or both upstream and downstream depending on the requirements of the specific duct geometry.

FIG. 14a illustrates filter pleats 12 mounted in the rigid frame 11 as in the embodiment of FIG. 8. In this embodiment, the rigid frame 11 is provided with moveable flaps 33, to which the ends of the filter pleats are glued or otherwise sealed. Flaps 33 may be formed as an integral part of the frame 11 or as components additional thereto. The sealed pleats prevent air bypass. In addition the flaps are arranged to hinge along the line of junction 34 between the frame and the flaps, so that folding down the flaps towards the plane of the pleat lines 13 causes to pleats to crumple and fold so as to occupy a space contained within the volume of the frame 11. This causes the depth of the filter to change from the expanded depth D2 to the folded depth D1 so as to be able to be inserted into a standard filter slot. It should be noted that the dimensions of the rigid frame W, L and D1 always remain constant, both during this folding process and during the subsequent insertion of the filter into the standard filter slot.

In FIG. 14b, the filter frame 11 remains unchanged. However the flaps 33 are now folded down to the level of the frame so that the whole filter now has a depth D1 equal to the frame depth. The pleat ends remain sealed to the surface of the flap 33. The pleat fold lines 13a are now crumpled and pushed down to occupy a depth equal to or less than the standard slot width. The movement of the flaps, both folding and unfolding, can be effected by means of a drawstring threaded through the frame and pullable from the outside of the frame to facilitate insertion and removal of the filter from the duct. Alternatively the flaps can be spring loaded or provided with intrinsic springiness to allow folding down and re-erection under the influence of the insertion force and the presence of the immovable edges of the standard slot.

FIG. 15 shows a further embodiment of the invention in which a frame 11 similar to the frame 11 in FIG. 7 contains filter material formed from an array of bags 36 preferably of cylindrical or conical shape, of a height greater than the frame depth D1, which are supported by spring elements or provided with intrinsic springiness so as to fold down to the frame depth on insertion of the filter into the standard slot.

FIGS. 16a and 16b show a single bag of the filter of FIG. 15, provided with an internal spring 39 to allow folding and re-erection of the filter. FIG. 16a shows the bag 36 fully expanded beyond the limit of the upstream frame edge 37. The downstream edge of the filter is shown as 38. FIG. 16b shows the bag folded down to the depth of the upstream edge of the frame.

In a further embodiment of the present invention the filter is pleated in rectangular folds. This embodiment is described with reference to FIGS. 17a, 17b, 17c, 18a, 18b, 19a, 19b, 20a and 20b.

One distinct advantage of a filter pleated in rectangular folds is that it will readily collapse to an almost flat state by bending along the line of the pleat. FIG. 17a shows deployed rectangular pleats with the base pleats 40 fixed (say to the filter frame). The non-fixed pleat tops 41 are free to bend as shown in FIG. 17b until the pleats are almost lying flat as shown in FIG. 17c.

It should be noted that the most popular form of filter pleat i.e. the triangular or V-pleat does not lend itself to folding down in this manner. Significant pressure is required to bend the pleats, which may lead to their being distorted, deformed, crushed and/or bent. Due to the fact that the rectangular pleat cross section folds as a parallelogram, the folded faces of the filter material retain the same shape and therefore do not introduce distortion forces to impede folding. Folding down of rectangular pleats is not reliant on any elastic properties of the filter material apart from the ability to bend along the crease of the pleat.

Each of FIGS. 18a, 19a and 20a show a section across the filter at right angles to the pleat folds. Each of FIGS. 18b, 19b and 20b show a section down the filter parallel to the pleat folds.

FIGS. 18a and 18b show the folded-down state of the filter frame 43 prior to insertion in the standard slot. FIG. 18a shows a section through the length of the filter showing the pleats 42 folded down. FIG. 18b shows a section through the width of the filter showing two folded-down filter side-flaps 44.

FIGS. 19a and 19b show the filter as if fully inserted in the slot and with the filter side-flaps 44 opened. Means for opening the side flaps could include springs, elastic tension in the material of the flaps or other methods.

FIGS. 20a and 20b shows the filter fully deployed. To deploy the filter to its full height when within the slot of the air conditioner, chord or tape (not shown) can be fixed to the tops 45 of the rectangular pleats. This chord is then drawn through the exit of the slot and causes the pleats to rise to their full height. The side flaps 44 now act to provide an air seal to prevent air flowing around the filter rather than through it.

To provide an improved air seal at the ends of the deployed rectangular pleats it may be advantageous to cover the side-flaps 44 with a thin layer of foam or soft spongy material 46. To remove the filter from within the slot at the end of its life, first the chord or tape is used to fold down the pleats of the filter and then the side flaps can be folded down using draw-strings or other means and finally the filter can be withdrawn.

The advantage of the present invention relies on the deployment of a pleated filter of greater depth than a standard “one inch” filter. In order to clearly demonstrate improved filter efficiency and reduced pressure drop, two small test filters were built. Both filters were made using a typical, commercially available, electret medium for use in US, ducted, whole-house filters. Both filters were made with a pleat spacing of one inch (distance from one pleat peak to the next pleat peak on the same side of the filter) The first filter is representative of a “standard filter”, being pleated to a depth of 22 mm (i.e. the pleat height or maximum peak-to-trough amplitude was 22 mm). The second filter was constructed in accordance with the invention and was pleated to a depth of three inches. Both filters were constructed in a 5×5 inch rigid frame and tests carried out in a duct of similar dimensions.

Filter efficiencies were determined at various air velocities in the duct. Air blown down the duct was loaded with an appropriate concentration of a sodium chloride particulate aerosol. Filter efficiency was determined by measuring the change in particle concentration from a position upstream and a position downstream of the filter. Measurements were made using a Handheld 3016 particle counter, available from Lighthouse Worldwide Solutions, on the 0.3 micrometer particle size range. The velocity of the air flow in the duct was measured using a model Q580365 hot wire anemometer, available from Omega Engineering Limited. Pressure drop across a filter was measured using a 2020P Sifam pressure meter.

The results of the efficiency and pressure drop tests for both the standard and inventive filters are shown in Tables 1 and 2 below.

TABLE 1

| | Efficiency (%) | |
|---|---|---|
| | Standard | Invention |
| Duct | 22 mm Deep | 3″ Deep |
| Velocity | 1″ Pleat | 1″ Pleat |
| (m/s) | Spacing | Spacing |
| 0.5 | 80.5 | 85.3 |
| 1.0 | 66.2 | 90.0 |
| 1.5 | 53.3 | 78.8 |
| 2.0 | 51.8 | 75.3 |
| 2.5 | 46.7 | 60.1 |

TABLE 2

| | Pressure Drop (Pa) | |
|---|---|---|
| | Standard | Invention |
| Duct | 22 mm Deep | 3″ Deep |
| Velocity | 1″ Pleat | 1″ Pleat |
| (m/s) | Spacing | Spacing |
| 0.5 | 6.3 | 2.0 |
| 1.0 | 14.2 | 4.6 |
| 1.5 | 23.8 | 8.4 |
| 2.0 | 34.7 | 18.8 |
| 2.5 | 45.6 | 36.7 |

Typical domestic duct air velocities would centre around 1.5 m/s, but with some systems air velocities may reach 2.0 or even 2.5 m/s.

It is clear from the results in Table 1 that the efficiency of the inventive filter (having a 3 inch peak-to-trough amplitude) is significantly better than the 22 mm deep (prior art) filter at all duct air velocities.

Also, it is clear from Table 2 that the pressure drop of the inventive filter is markedly lower than that of the prior art filter.

Thus implementation of a filter in accordance with the present invention can provide increased efficiency and lower pressure drop, which may also result in higher dirt loading and a longer operational lifetime.

1. An air cleaning filter for an air conditioning system comprising a rigid frame having a length, a width and a depth, to which flexible filter material is mounted, the filter material being of greater cross-sectional area than the rigid frame, and including at least two peaks and one trough therein, the maximum peak-to-trough amplitude of which is greater than the depth of the rigid frame.

2. An air cleaning filter as claimed in claim 1 in which the length and width thereof are adapted so as to be positioned, in use, in a direction that is substantially perpendicular to the direction of airflow of air being filtered, whilst the depth thereof is adapted so as to be positioned, in use, in a direction that is substantially parallel to said direction of airflow.

3. An air cleaning filter as claimed in claim 1 wherein the filter material is a sheet of flexible filter material.

4. An air cleaning filter as claimed in claim 3 wherein the sheet of filter material is provided within the rigid frame.

5. An air cleaning filter as claimed in claim 3 wherein the sheet of filter material is undulating.

6. An air cleaning filter as claimed in claim 5 wherein the undulations in the sheet of filter material are in the form of pleats.

7. An air cleaning filter as claimed in claim 6 wherein the pleats have well-defined creases at the apices thereof.

8. An air cleaning filter as claimed in claim 5 wherein the filter further comprises a plurality of guides about which the sheet of filter material undulates.

9. An air cleaning filter as claimed in claim 8 wherein the plurality of guides extends within the filter frame.

10. An air cleaning filter as claimed in claim 8 wherein the plurality of guides comprises a number of regularly and evenly spaced guides.

11. An air conditioning system comprising an air cleaning filter as claimed in claim 1.

12. An air conditioning system as claimed in claim 11 in which the air cleaning filter is located such that the length and width thereof are positioned in a direction that is substantially perpendicular to the direction of airflow of the air being filtered, whilst the depth thereof is positioned in a direction that is substantially parallel to said direction of airflow.
